(19) United States
(12) Patent Application Publication
(10) Pub. No.: US 2016/0238091 A1
(43) Pub. Date: Aug. 18, 2016

(54) FREE-WHEEL DEVICE FOR AN AUTOMATIC TRANSMISSION

(71) Applicant: Schaeffler Technologies AG & Co. KG, Herzogenaurach (DE)

(72) Inventor: Alexander Reimchen, Herzogenaurach (DE)

(73) Assignee: Schaeffler Technologies AG & Co. KG, Herzogenauarh (DE)

(21) Appl. No.: 15/013,194

(22) Filed: Feb. 2, 2016

(30) Foreign Application Priority Data
Feb. 17, 2015 (DE) 102015202825.9

(51) Int. Cl. F16D 41/12

(52) U.S. Cl. CPC F16D 41/12

(57) ABSTRACT

A free-wheel device for an automatic transmission of a motor vehicle is provided, including a rotating inner ring (1) and a stationary, fixed outer ring (2), a cage (3) arranged radially between the inner ring (1) and the outer ring (2) for holding clamping bodies. The outer ring (2) is formed of a thrust ring (4) and a ring washer (5) that is arranged axially on the thrust ring (4) and connected locked in rotation with the thrust ring (4). The thrust ring (4) is provided for receiving tangential forces, and the ring washer (5) has radial formations (6) on an outer circumferential surface (7) for the stationary fixing of the outer ring (2).

### INCORPORATION BY REFERENCE

The following documents are incorporated herein by reference as if fully set forth: German Patent Application No. 102015202825.9, filed Feb. 17, 2015.

### BACKGROUND

The invention relates to a free-wheel device for an automatic transmission of a motor vehicle, comprising a rotating inner ring and a stationary, fixed outer ring, as well as a cage arranged radially between the inner ring and the outer ring for holding clamping bodies.

Such free-wheel devices are known, for example, from DE 10 2009 037 255 A1 and DE 10 2010 053 358 A1. Free-wheel devices, in particular, roller free-wheel devices, allow rotation in a defined direction of rotation, while the rotation in the other direction can be blocked by the clamping rollers clamping on clamping ramps. The field of application of such free-wheel devices extends, in particular, to torque converters or automatic transmissions in the automotive industry or in corresponding industrial machines.

The roller free-wheel device disclosed in DE 10 2009 037 255 A1 comprises a cylindrical outer ring with clamping ramps formed on the inner surface, multiple clamping rollers that are spring-loaded against the clamping ramps, and a cage that is arranged locked in rotation in the outer ring and on which the clamping rollers are held and on which springs used for spring-loading the clamping rollers are arranged on cage connecting pieces. The cage connecting pieces extend between two cage rings.

The clamping roller free-wheel device known from DE 10 2010 053 358 A1 has, in contrast, an outer ring that is driven by a lug of a connecting rod over a specified angle, in order to transfer torque to the inner ring over this range of angles in clamping operation of the clamping rollers, while for a reverse movement of the connecting rod, the clamping roller free-wheel device is overrun in the idle mode. Such a lug, however, can also be used for the stationary fixing of the outer ring. Furthermore, it is also usual that the outer ring has, on the outer circumferential surface, a structure or geometry that is used for the stationary fixing of the outer ring.

For example, free-wheel devices are used in automatic transmissions as boosting elements and reverse blocks, in order to realize shifting processes. The outer ring is usually fixed stationary in the housing, wherein this has, as previously explained, a geometry on its outer circumferential surface. The outer rings are very strongly loaded by tangential forces and therefore have a solid construction. The geometry on the outer circumferential surface of the outer ring is usually formed by broaching, shaping, or hobbing. Due to this method for forming the geometry on the outer circumferential surface of the outer ring, the production of the outer ring is relatively time and cost intensive. Other methods, such as sintering or forging, are not used as much due to additional, accumulating disadvantages.

### SUMMARY

Therefore, the objective of the present invention is to create a free-wheel device that is optimized with respect to production and can be produced in an especially simple, quick, and economical way.

According to the invention, the outer ring includes a thrust ring and a ring washer that is arranged axially on the thrust ring and connected locked in rotation with the thrust ring, wherein the thrust ring is provided for receiving tangential forces, and wherein the ring washer has radial formations on an outer circumferential surface for the stationary fixing of the outer ring. The separation of the thrust ring and ring washer, which form the outer ring guided together and connected locked in rotation with each other, enables an especially simple and quick production of the outer ring. Furthermore, due to the different loads between the thrust ring and ring washer, the dimensions of the two components can be optimized. The thrust ring indeed requires a solid construction due to the tangential forces that occur due to the expansion when the free-wheel device is clamped, while the ring washer is not loaded by any tangential forces, so that only the function of the anti-rotation locking must be fulfilled by the stationary fixing. In this way, the ring washer can have a construction that is relatively flat and thus saves both installation space and also weight.

According to a preferred embodiment, the ring washer is formed from at least two ring segments that are each arranged axially on the thrust ring and are connected locked in rotation with the thrust ring. Consequently, the ring washer can also be formed of several ring segments and does not have to have a one-piece construction. Depending on the field of use and dimensions, a multiple-part construction of the ring washer is especially advantageous. A segmented construction of the ring washer, in particular, decreases the requirements for materials in production.

Advantageously, the thrust ring and the ring washer or the ring washer formed of multiple ring segments are connected to each other with a positive fit connection. In an especially preferred way, the thrust ring and the ring washer or the ring washer consisting of multiple ring segments are welded together. Furthermore, however, it is also conceivable for a non-welded material connection between the thrust ring and the ring washer to connect the thrust ring and the ring washer to each other through adhesion.

In addition, the ring washer or the ring washer formed of multiple ring segments is preferably made from a non-cutting method. In an especially preferred way, the ring washer or the ring washer consisting of multiple ring segments is produced by stamping. Additional non-cutting production methods, in particular, precision blanking and bending, are also conceivable.

The invention includes the thrust ring being made from a steel material that can be annealed. Advantageously, the steel material is case-hardened.

According to another preferred embodiment, the radial formations are distributed non-uniformly on the outer circumferential surface of the ring washer or the ring washer formed of multiple ring segments. Furthermore, the radial formations can also have different dimensions in the circumferential direction. This is used especially in that only one single receiving position is possible for the installation of the outer ring in the housing.

### BRIEF DESCRIPTION OF THE DRAWINGS

Additional measures with respect to the invention will be described in more detail below together with the description of preferred embodiments of the invention with reference to the figures. Shown are:

FIG. 1 a schematic section view for illustrating the construction of a free-wheel device according to the invention, comprising an inner ring, an outer ring formed from a thrust ring and a ring washer, and also a cage arranged radially in-between,

FIG. 2 a perspective view for illustrating the construction of a free-wheel device according to the invention according to a first embodiment, and

FIG. 3 a perspective view for illustrating the construction of a free-wheel device according to the invention according to a second embodiment.

### DETAILED DESCRIPTION OF THE PREFERRED EMBODIMENTS

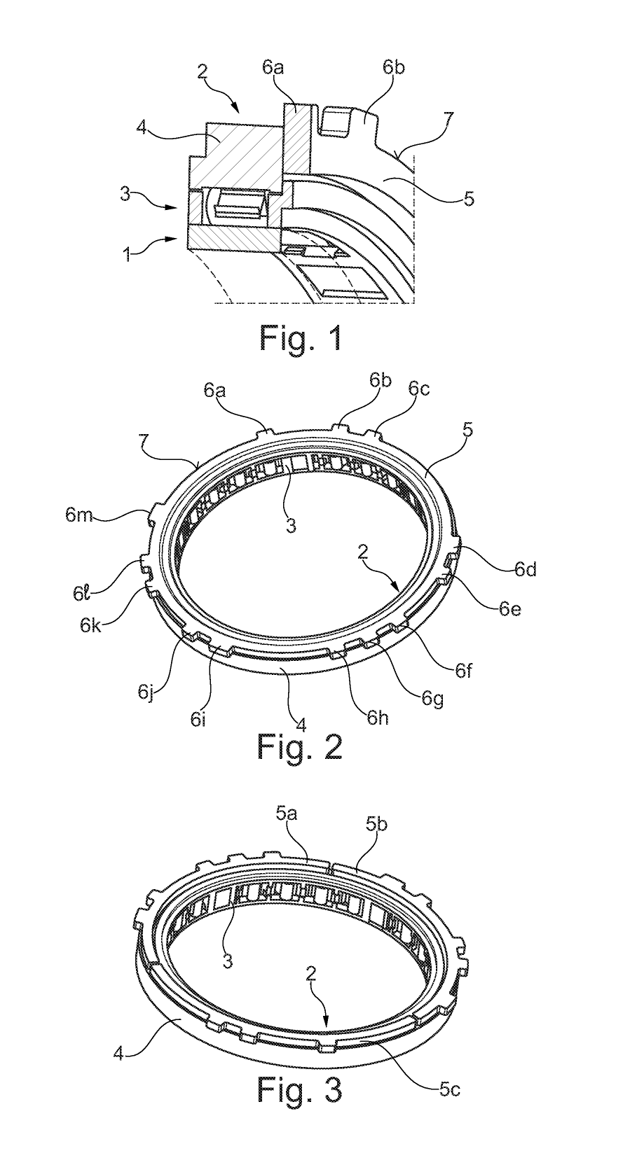

According to FIG. 1, a free-wheel device according to the invention for an automatic transmission of a motor vehicle has a rotating inner ring 1 and a stationary, fixed outer ring 2, and also a cage 3 arranged radially between the inner ring 1 and the outer ring 2 for holding clamping bodies—not fully shown here. The outer ring 2 is formed of a thrust ring 4 and a ring washer 5 arranged axially on the thrust ring 4 and connected locked in rotation with the thrust ring 4. Here, the thrust ring 4 is provided for receiving tangential forces. In contrast, the ring washer 5 has, for stationary fixing of the outer ring 2, radial formations 6a, 6b that are arranged on an outer circumferential surface 7. The thrust ring 4 and the ring washer 5 are connected to each other with a positive fit connection, in particular, by welding. Furthermore, the ring washer 5 is made with a non-cutting method, in particular, by stamping. In contrast, the thrust ring 4 has a solid construction and is made from a steel material that can be annealed. In particular, a forging blank is suitable for the production of the thrust ring 4.

From FIG. 2 it is clear that the radial formations 6a-6m are distributed non-uniformly on the outer circumferential surface 7 of the ring washer 4. Furthermore, the ring washer 5 has a one-piece construction. In addition, the radial formations 6a-6m have different dimensions in the circumferential direction. For simplification, in FIG. 2 only the outer ring 2, formed of the thrust ring 4 and the ring washer 5, as well as the cage 3, is shown.

FIG. 3 shows another embodiment of the free-wheel device. According to FIG. 3, the ring washer 5 is made from three ring segments 5a, 5b, 5c that are each arranged axially on the thrust ring 4 and are connected locked in rotation with the thrust ring 4. The thrust ring 4 and the ring segments 5a, 5b, 5c of the ring washer 5 are connected to each other with a positive fit connection, in particular, through welding. Furthermore, the ring segments 5a, 5b, 5c of the ring washer 5 are produced in a non-cutting method, in particular, through stamping. For simplification, in FIG. 3 only the outer ring 2, formed of the thrust ring 4 and the three ring segments 5a, 5b, 5c of the ring washer 5, as well as the cage 3, is shown.

### LIST OF REFERENCE SYMBOLS

1 Inner ring

2 Outer ring

3 Cage

4 Thrust ring

5 Ring washer

5a-5c Ring segment

6a-6m Radial formation

7 Outer circumferential surface

1. A free-wheel device for an automatic transmission of a motor vehicle, comprising a rotating inner ring (1), a stationary, fixed outer ring (2), a cage (3) arranged radially between the inner ring (1) and the outer ring (2) for holding clamping bodies, the outer ring (2) is formed of a thrust ring (4) and a ring washer (5) arranged axially on the thrust ring (4) and connected locked in rotation with the thrust ring (4), the thrust ring (4) is provided to receive tangential forces, and the ring washer (5) has radial formations (6) on an outer circumferential surface (7) for stationary fixing of the outer ring (2).

2. The free-wheel device according to claim 1, wherein the ring washer (5) is formed from at least two ring segments (5a, 5b) that are each arranged axially on the thrust ring (4) and are connected locked in rotation with the thrust ring (4).

3. The free-wheel device according to claim 1, wherein the thrust ring (4) and the ring washer (5) are connected to each other with a positive fit connection.

4. The free-wheel device according to claim 3, wherein the thrust ring (4) and the ring washer (5) are welded together.

5. The free-wheel device according to claim 1, wherein the ring washer (5) is produced with a non-cutting method.

6. The free-wheel device according to claim 5, wherein the ring washer (5) is stamped.

7. The free-wheel device according to claim 1, wherein the thrust ring (4) is made from a steel material that is annealable.

8. The free-wheel device according to claim 1, wherein the radial formations (6a, 6b) are distributed non-uniformly on the outer circumferential surface (7) of the ring washer (4).
